(19) United States
(12) Patent Application Publication
(10) Pub. No.: US 2011/0298930 A1
(43) Pub. Date: Dec. 8, 2011

(54) Integrated Wireless Location and Surveillance System

(75) Inventors: Manlio Allegra, Los Altos Hills, CA (US); Martin Feuerstein, Redmond, WA (US); Kevin Alan Lindsey, Alexandria, VA (US); Mahesh B. Patel, Saratoga, CA (US); David Stevenson Spain, JR., Portola Valley, CA (US)

(73) Assignee: POLARIS WIRELESS, INC., Mountain View, CA (US)

(21) Appl. No.: 13/152,910

(22) Filed: Jun. 3, 2011

Related U.S. Application Data
(60) Provisional application No. 61/351,622, filed on Jun. 4, 2010.
(60) Provisional application No. 61/363,777, filed on Jul. 13, 2010.

(51) Int. Cl. H04N 7/18

(52) U.S. Cl. 348/159; 348/E07.085

(57) ABSTRACT

An integrated wireless location and surveillance system that provides distinct advantages over video and audio surveillance systems of the prior art is disclosed. The integrated system comprises (i) a surveillance system comprising a plurality of cameras, each covering a respective zone, and (ii) a wireless location system that is capable of providing to the surveillance system, at various points in time, an estimate of the location of a wireless terminal that belongs to a person of interest. The surveillance system intelligently selects the video feed from the appropriate camera, based on the estimated location of the wireless terminal, and delivers the selected video feed to a display. As a person of interest moves from one zone to another, the surveillance system is capable of dynamically updating which video feed is delivered to the display.

### CROSS-REFERENCE TO RELATED APPLICATIONS

This application claims the benefit of U.S. Provisional Patent Application No. 61/351,622, filed Jun. 4, 2010, entitled “Wireless Location System Control of Surveillance Cameras,” (Attorney Docket: 465-066us) and U.S. Provisional Patent Application No. 61/363,777, filed Jul. 13, 2010, entitled “Wireless Location System Control of Surveillance Cameras,” (Attorney Docket: 465-067us), which are also incorporated by reference.

### FIELD OF THE INVENTION

The present invention relates to wireless telecommunications in general, and, more particularly, to an integrated wireless location and surveillance system.

### BACKGROUND OF THE INVENTION

Video and audio surveillance systems are being deployed in increasing numbers, in both public and private venues, for security and counter-terrorism purposes.

### SUMMARY OF THE INVENTION

The present invention comprises an integrated wireless location and surveillance system that provides distinct advantages over video and audio surveillance systems of the prior art. In particular, the integrated system comprises (i) a surveillance system comprising a plurality of cameras, each covering a respective zone, and (ii) a wireless location system that is capable of providing to the surveillance system, at various points in time, an estimate of the location of a wireless terminal that is associated with a person or item of interest. The surveillance system intelligently selects the video feed from the appropriate camera, based on the estimated location of the wireless terminal, and delivers the selected video feed to a display. As a person of interest moves from one zone to another, the surveillance system is capable of dynamically updating which video feed is delivered to the display.

In accordance with the first illustrative embodiment of the present invention, each camera is a digital pan-zoom-tilt (PZT) closed-circuit television camera that is automatically and dynamically controlled to photograph the current estimated location of a particular wireless terminal, following its movement within the zone. In addition, a microphone is paired with each camera, such that movements of the camera keep the microphone pointing to the estimated location of the wireless terminal.

The second illustrative embodiment also employs digital pan-zoom-tilt (PZT) closed-circuit television cameras; however, rather than the system automatically controlling the selected camera to track the wireless terminal, the selected camera is subjected to the control of a user, who can manipulate the camera via an input device such as a mouse, touchscreen, and so forth.

In accordance with the third illustrative embodiment, each camera is a fixed, ultra-high-resolution digital camera with a fisheye lens that is capable of photographing simultaneously all of the locations within the associated zone. In this embodiment, rather than the camera being manipulated to track the estimated location of the wireless terminal, a sub-feed that comprises the estimated location is extracted from the video feed, and a magnification of the extracted sub-feed is delivered to a display.

The illustrative embodiments comprise: receiving, by a data-processing system: (i) an identifier of a wireless terminal, and (ii) an estimate of a location that comprises the wireless terminal; and transmitting, from the data-processing system, a signal that causes a camera to photograph the location.

### BRIEF DESCRIPTION OF THE DRAWINGS

FIG. 1 depicts a block diagram of the salient components of integrated wireless location and surveillance system 100, in accordance with the illustrative embodiments of the present invention.

FIG. 2 depicts a block diagram of the salient components of surveillance system 102, as shown in FIG. 1, in accordance with the illustrative embodiments of the present invention.

FIG. 3 depicts a block diagram of the salient components of surveillance apparatus 201-i, as shown in FIG. 2, where i is an integer between 1 and N inclusive, in accordance with the illustrative embodiments of the present invention.

FIG. 4 depicts a block diagram of the salient components of surveillance data-processing system 202, as shown in FIG. 2, in accordance with the illustrative embodiments of the present invention.

FIG. 5 depicts a block diagram of the salient components of surveillance server 401, as shown in FIG. 4, in accordance with the illustrative embodiments of the present invention.

FIG. 6 depicts a block diagram of the salient components of surveillance client 403, as shown in FIG. 4, in accordance with the illustrative embodiments of the present invention.

FIG. 7 depicts a flowchart of the salient tasks of integrated wireless location and surveillance system 100, as shown in FIG. 1, in accordance with the illustrative embodiments of the present invention.

FIG. 8 depicts a first detailed flowchart of task 790, as shown in FIG. 7, in accordance with the first illustrative embodiment of the present invention.

FIG. 9 depicts a second detailed flowchart of task 790, in accordance with the second illustrative embodiment of the present invention.

FIG. 10 depicts a detailed flowchart of subtask 920, as shown in FIG. 9, in accordance with the second illustrative embodiment of the present invention.

FIG. 11 depicts a detailed flowchart of subtask 930, as shown in FIG. 9, in accordance with the second illustrative embodiment of the present invention.

FIG. 12 depicts a third detailed flowchart of task 790, in accordance with the third illustrative embodiment of the present invention.

### DETAILED DESCRIPTION

For the purposes of this specification, the following terms and their inflected forms are defined as follows:
The term “location” is defined as a zero-dimensional point, a one-dimensional line, a two-dimensional area, or a three-dimensional volume.

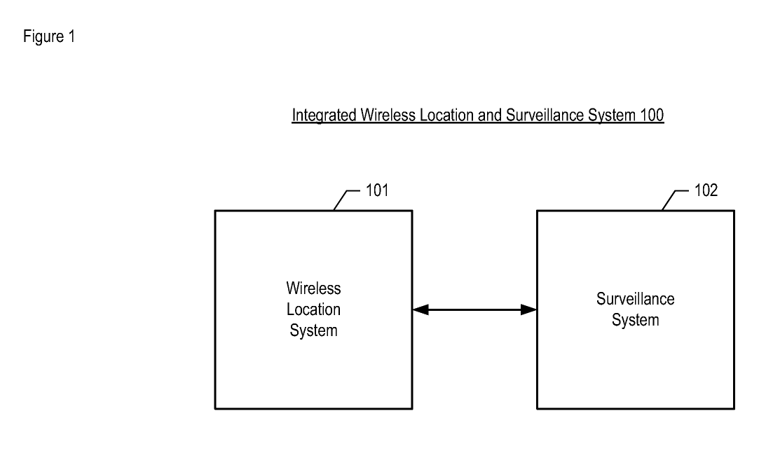

FIG. 1 depicts a block diagram of the salient components of integrated wireless location and surveillance system 100, in accordance with the illustrative embodiments of the present invention. As shown in FIG. 1, integrated wireless location and surveillance system 100 comprises wireless location system 101 and surveillance system 102, interconnected as shown.

Wireless location system 101 is a system that is capable of estimating the location of a plurality of wireless terminals (not shown in FIG. 1), of receiving location queries from surveillance system 102, and of reporting location estimates to surveillance system 102. As is well-known in the art, wireless location system 101 might be based on any one of a variety of technologies, such as radio frequency (RF) fingerprinting, Global Positioning System (GPS), triangulation, and so forth.

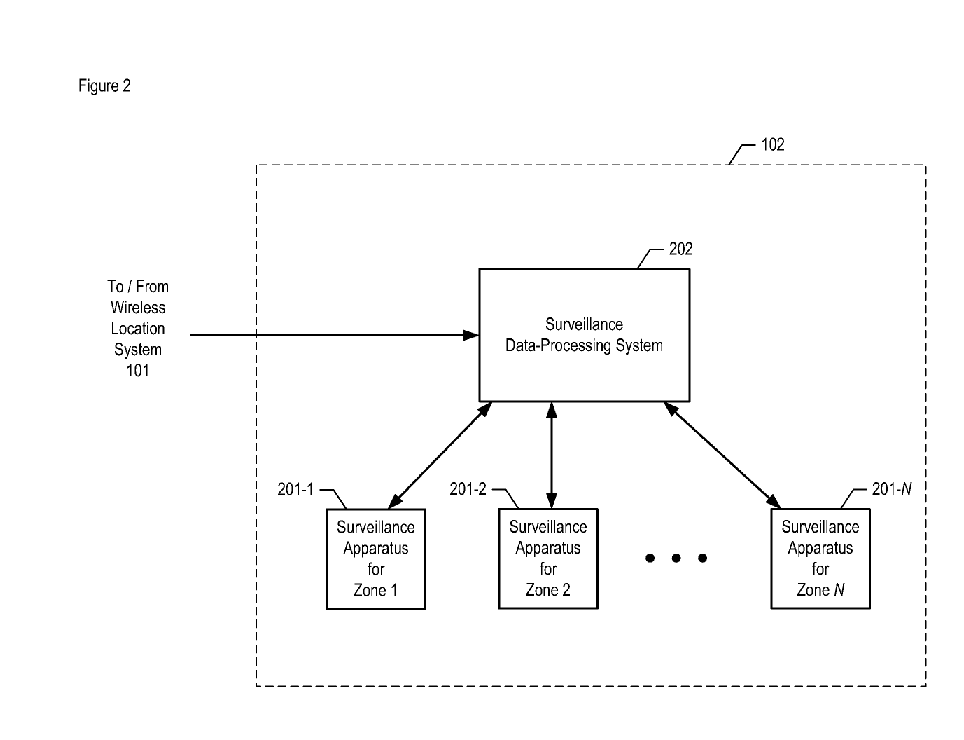

Surveillance system 102 is a system that is capable of delivering video and audio feeds from a plurality of zones, of transmitting location queries to wireless location system 101, of receiving location estimates of wireless terminals from wireless location system 101, and of providing the functionality of the present invention. Surveillance system 102 is described in detail below and with respect to FIGS. 2 through 12.

FIG. 2 depicts a block diagram of the salient components of surveillance system 102, in accordance with the illustrative embodiments of the present invention. As shown in FIG. 2, surveillance system 102 comprises surveillance data-processing system 202, and surveillance apparatuses 201-1 through 201-N, where N is a positive integer, interconnected as shown.

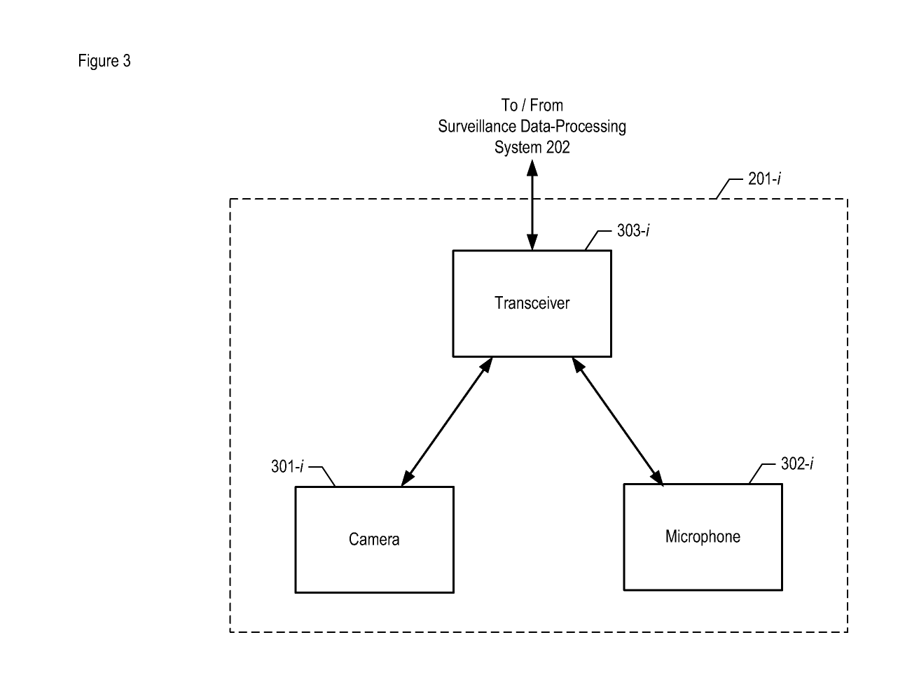

Surveillance apparatus 201-i, where i is an integer between 1 and N inclusive, is a system that is capable of providing video and audio feeds from a respective zone. Surveillance apparatus 201-i is described in detail below and with respect to FIG. 3.

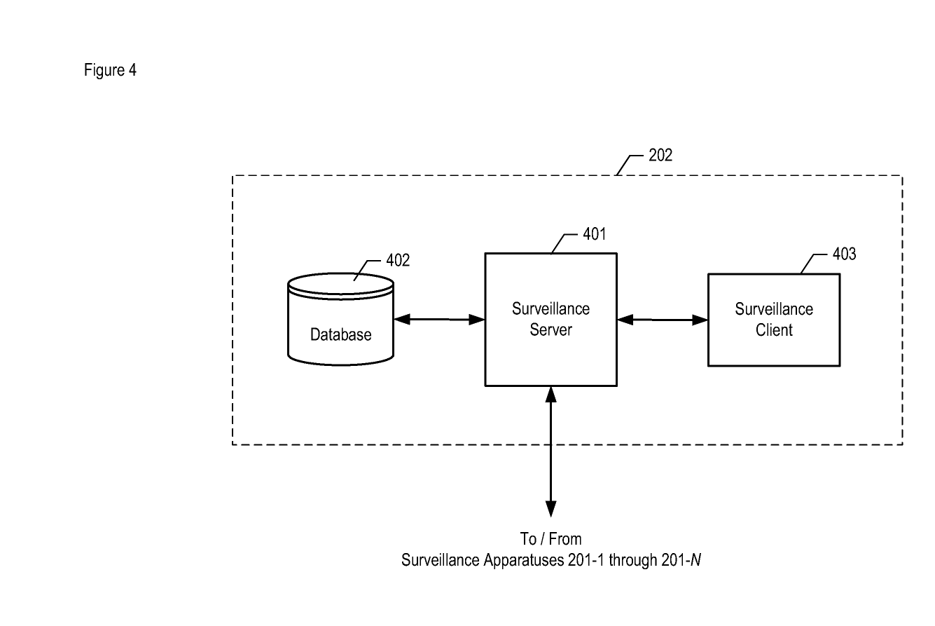

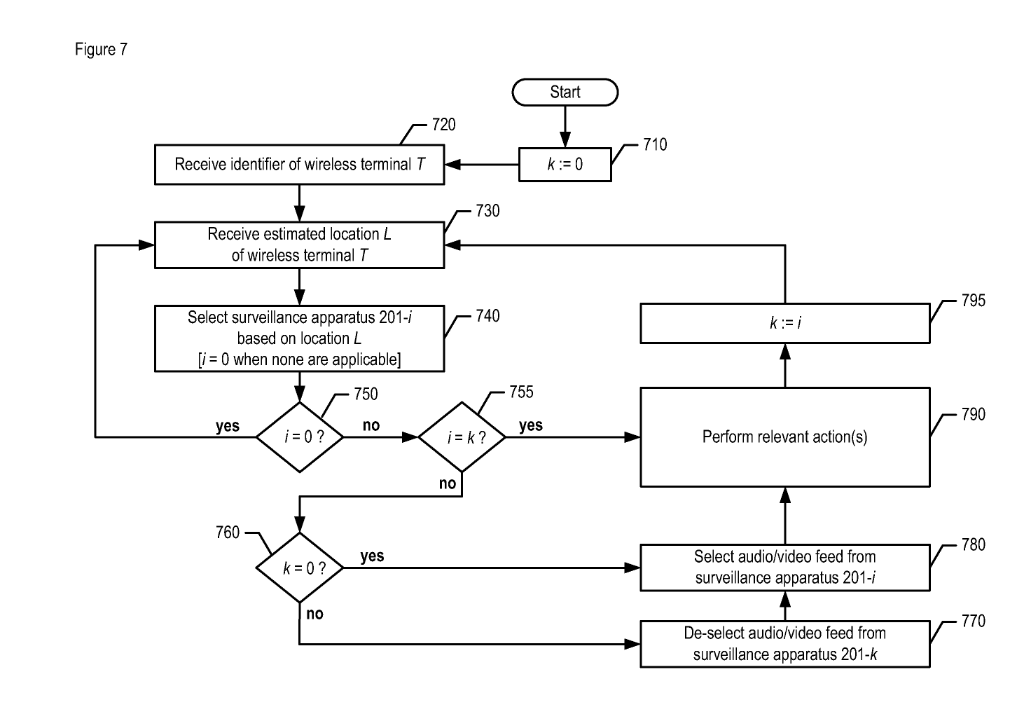

Surveillance data-processing system 202 is a system that is capable of receiving video and audio feeds from surveillance apparatuses 201-1 through 201-N, of transmitting command signals to surveillance apparatuses 201-1 through 201-N, of receiving location estimates of wireless terminals from wireless location system 101, and of performing the pertinent tasks of the methods of FIGS. 7 through 12 below. Surveillance data-processing system 202 is described in detail below and with respect to FIGS. 4 through 6.

FIG. 3 depicts a block diagram of the salient components of surveillance apparatus 201-i, where i is an integer between 1 and N inclusive, in accordance with the illustrative embodiments of the present invention. As shown in FIG. 3, surveillance apparatus 201-i comprises camera 301-i, microphone 302-i, and transceiver 303-i, interconnected as shown.

Camera 301-i is capable of photographing locations in zone i, of forwarding images to transceiver 303-i, of receiving command signals via transceiver 303-i, and of performing the received commands, in well-known fashion. In accordance with the first and second illustrative embodiments of the present invention, camera 301-i is a digital pan-zoom-tilt (PZT) closed-circuit television camera that is capable of photographing every location within its associated zone i. In accordance with the third illustrative embodiment of the present invention, camera 301-i is a fixed, ultra-high-resolution digital camera with a fisheye lens capable of photographing simultaneously all locations within zone i. As will be appreciated by those skilled in the art, some other embodiments of the present invention might employ a different type of camera, and it will be clear to those skilled in the art, after reading this disclosure, how to make and use such alternative embodiments.

Microphone 302-i is capable of receiving sound pressure waves from locations in zone i, of converting these waves into electromagnetic signals, of forwarding the electromagnetic signals to transceiver 303-i, and of receiving command signals via transceiver 303-i, in well-known fashion. In accordance with the first and second illustrative embodiments of the present invention, microphone 302-i is mounted on camera 301-i such that panning movements of camera 301-i accordingly change the direction in which microphone 302-i is pointed. In accordance with the third illustrative embodiment of the present invention, microphone 302-i is capable of changing its orientation directly in response to command signals received via transceiver 303-i, rather than indirectly via camera 301-i, as in the third illustrative embodiment camera 301-i is fixed.

Transceiver 303-i is capable of receiving electromagnetic signals from surveillance data-processing system 202 and forwarding these signals to camera 301-i and microphone 302-i, and of receiving electromagnetic signals from camera 301-i and microphone 302-i and transmitting these signals to surveillance data-processing system 202, in well-known fashion.

As will be appreciated by those skilled in the art, in some other embodiments of the present invention surveillance apparatus 201-i might comprise other sensors or devices in addition to, or in lieu of, camera 301-i and microphone 302-i, such as an infrared (IR)/heat sensor, a motion detector, a Bluetooth monitoring/directional antenna, a radio frequency identification (RFID) reader, a radio electronic intelligence gathering device, etc. Furthermore, in some other embodiments of the present invention surveillance apparatus 201-i might also comprise active devices that are capable of being steered or triggered based on location information, such as electronic or radio jammers, loudspeakers, lasers, tasers, guns, etc., as well as active radio sources that are designed to fool and elicit information from wireless terminals (e.g. fake cell sites, etc.). In any case, it will be clear to those skilled in the art, after reading this disclosure, how to make and use embodiments of the present invention that employ such variations of surveillance apparatus 201-i.

FIG. 4 depicts a block diagram of the salient components of surveillance data-processing system 202, in accordance with the illustrative embodiments of the present invention. As shown in FIG. 4, surveillance data-processing system 202 comprises surveillance server 401, database 402, and surveillance client 403, interconnected as shown.

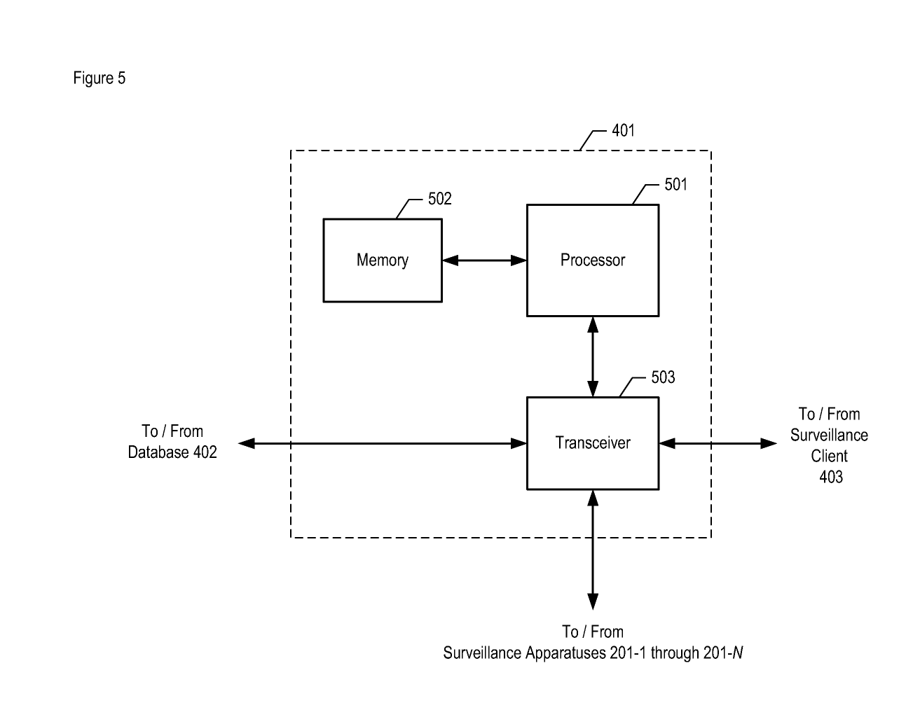

Surveillance server 401 is a data-processing system that is capable of receiving video and audio feeds from surveillance apparatuses 201-1 through 201-N and forwarding these feeds to surveillance client 403, of generating command signals and transmitting the generated command signals to surveillance apparatuses 201-1 through 201-N, of receiving command signals from surveillance client 403 and transmitting the received command signals to surveillance apparatuses 201-1 through 201-N, of receiving location estimates of wireless terminals from wireless location system 101, of reading from and writing to database 402, and of performing the pertinent tasks of the methods of FIGS. 7 through 12 below. Surveillance server 401 is described in detail below and with respect to FIG. 5.

Database 402 is capable of providing persistent storage of data and efficient retrieval of the stored data, in well-known fashion. In accordance with the illustrative embodiments of the present invention, database 402 is a relational database that associates user identifiers (e.g., social security numbers, service provider customer account numbers, etc.) with wireless terminal identifiers (e.g., telephone numbers, etc.). As will be appreciated by those skilled in the art, in some other embodiments of the present invention database 402 might store other data in addition to, or instead of, that of the illustrative embodiment, or might be some other type of database (e.g., an object-oriented database, a hierarchical database, etc.), or both, and it will be clear to those skilled in the art, after reading this disclosure, how to make and use such alternative embodiments of the present invention.

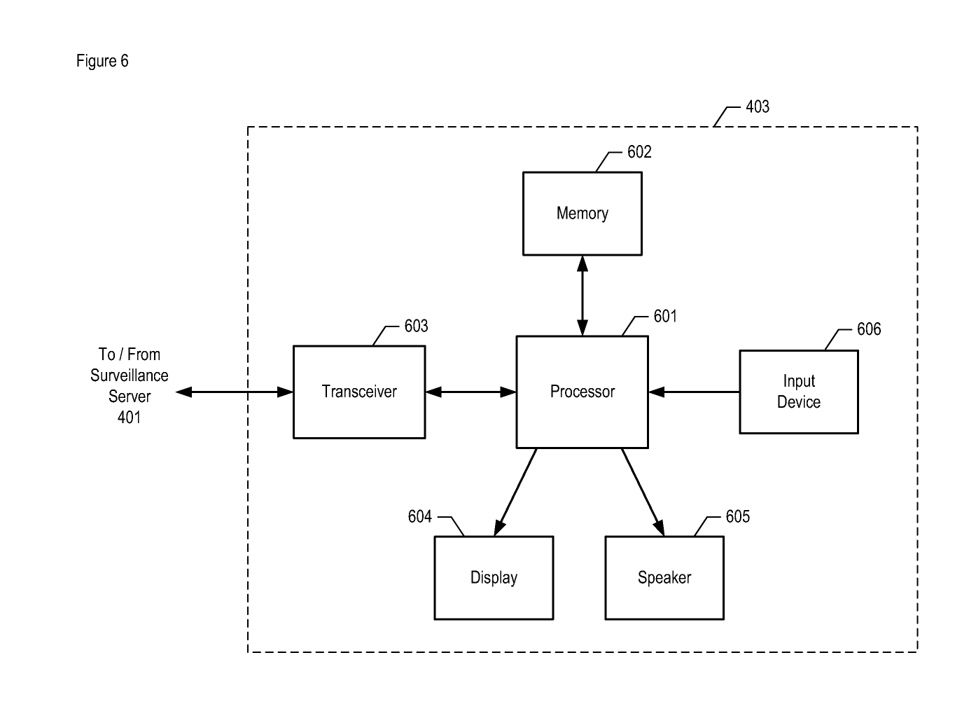

Surveillance client 403 is a data-processing system that is capable of receiving video and audio feeds via surveillance server 401, of receiving command signals from a user for remotely manipulating surveillance apparatuses 201-1 through 201-N and transmitting these command signals to surveillance server 401, of receiving command signals from a user for locally manipulating the display of the received video feeds, and of performing the pertinent tasks of the methods of FIGS. 7 through 12 below. Surveillance server 403 is described in detail below and with respect to FIG. 6.

FIG. 5 depicts a block diagram of the salient components of surveillance server 401, in accordance with the illustrative embodiments of the present invention. As shown in FIG. 5, surveillance server 401 comprises processor 501, memory 502, and transceiver 503, interconnected as shown.

Processor 501 is a general-purpose processor that is capable of receiving information from transceiver 503, of reading data from and writing data into memory 502, of executing instructions stored in memory 502, and of forwarding information to transceiver 503, in well-known fashion. As will be appreciated by those skilled in the art, in some alternative embodiments of the present invention processor 501 might be a special-purpose processor, rather than a general-purpose processor.

Memory 502 is capable of storing data and executable instructions, in well-known fashion, and might be any combination of random-access memory (RAM), flash memory, disk drive, etc. In accordance with the illustrative embodiments, memory 502 stores executable instructions corresponding to the pertinent tasks of the methods of FIGS. 7 through 12 below.

Transceiver 503 is capable of receiving signals from surveillance apparatuses 201-1 through 201-N, database 402, and surveillance client 403, and forwarding information encoded in these signals to processor 501; and of receiving information from processor 501 and transmitting signals that encode this information to surveillance apparatuses 201-1 through 201-N, database 402, and surveillance client 403, in well-known fashion.

FIG. 6 depicts a block diagram of the salient components of surveillance client 403, in accordance with the illustrative embodiments of the present invention. As shown in FIG. 6, surveillance client 403 comprises processor 601, memory 602, transceiver 603, display 604, speaker 605, and input device 606, interconnected as shown.

Processor 601 is a general-purpose processor that is capable of receiving information from transceiver 603, of reading data from and writing data into memory 602, of executing instructions stored in memory 602, and of forwarding information to transceiver 603, in well-known fashion. As will be appreciated by those skilled in the art, in some alternative embodiments of the present invention processor 202 might be a special-purpose processor, rather than a general-purpose processor.

Memory 602 is capable of storing data and executable instructions, in well-known fashion, and might be any combination of random-access memory (RAM), flash memory, disk drive, etc. In accordance with the illustrative embodiments, memory 602 stores executable instructions corresponding to the pertinent tasks of the methods of FIGS. 7 through 12 below.

Transceiver 603 is capable of receiving signals from surveillance server 401 and forwarding information encoded in these signals to processor 601, and of receiving information from processor 601 and transmitting signals that encode this information to surveillance server 401, in well-known fashion.

Display 604 is an output device such as a liquid-crystal display (LCD), cathode-ray tube (CRT), etc. that is capable of receiving electromagnetic signals encoding images and text from processor 601 and of displaying the images and text, in well-known fashion.

Speaker 605 is a transducer that is capable of receiving electromagnetic signals from processor 601 and of generating corresponding acoustic signals, in well-known fashion.

Input device 606 is a device such as a keyboard, mouse, touchscreen, etc. that is capable of receiving input from a user and of transmitting signals that encode the user input to processor 601, in well-known fashion.

FIG. 7 depicts a flowchart of the salient tasks of integrated wireless location and surveillance system 100, in accordance with the illustrative embodiments of the present invention.

At task 710, variable k is initialized to zero by surveillance system 102

At task 720, an identifier of a wireless terminal T is received by surveillance system 102 and forwarded to wireless location system 101, in well-known fashion.

At task 730, an estimated location L of wireless terminal T is received by surveillance system 102 from wireless location system 101, in well-known fashion.

At task 740, surveillance system 102 selects a surveillance apparatus 201-i based on location L, where i is an integer between 1 and N inclusive, such that location L is within the zone i monitored by surveillance apparatus 201-i. If location L is not within any of zones 1 through N, then variable i is set to zero.

At task 750, surveillance system 102 tests whether i equals zero; if so, execution continues back at task 730, otherwise execution proceeds to task 755.

At task 755, surveillance system 102 tests whether i equals k; if not, execution proceeds to task 760, otherwise execution continues at task 790.

At task 760, surveillance system 102 tests whether k equals zero; if not, execution proceeds to task 770, otherwise execution continues at task 780.

At task 770, surveillance system 102 de-selects the audio/video feed from surveillance apparatus 201-k, in well-known fashion.

At task 780, surveillance system 102 selects the audio/video feed from surveillance apparatus 201-i, in well-known fashion.

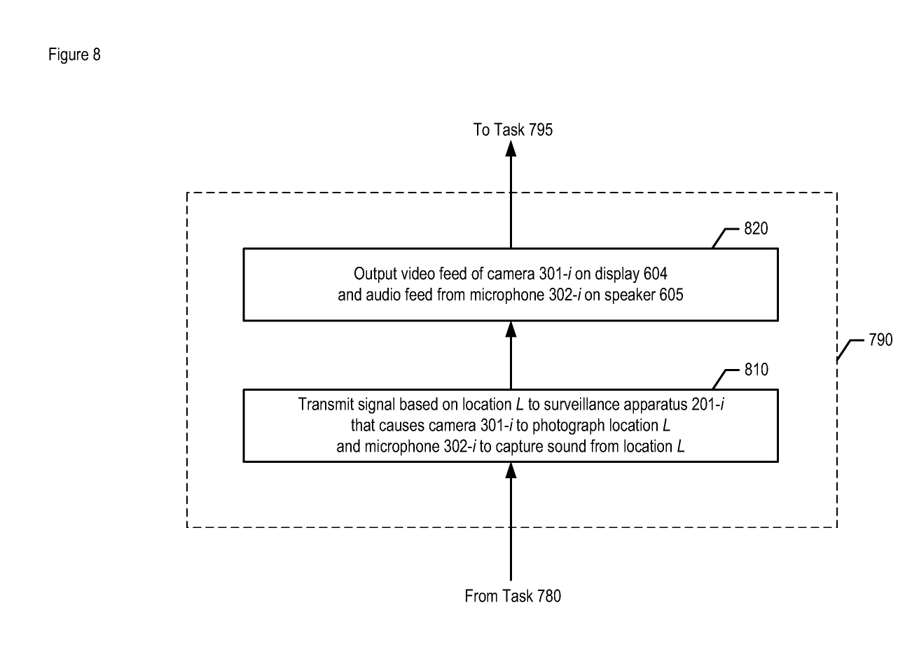

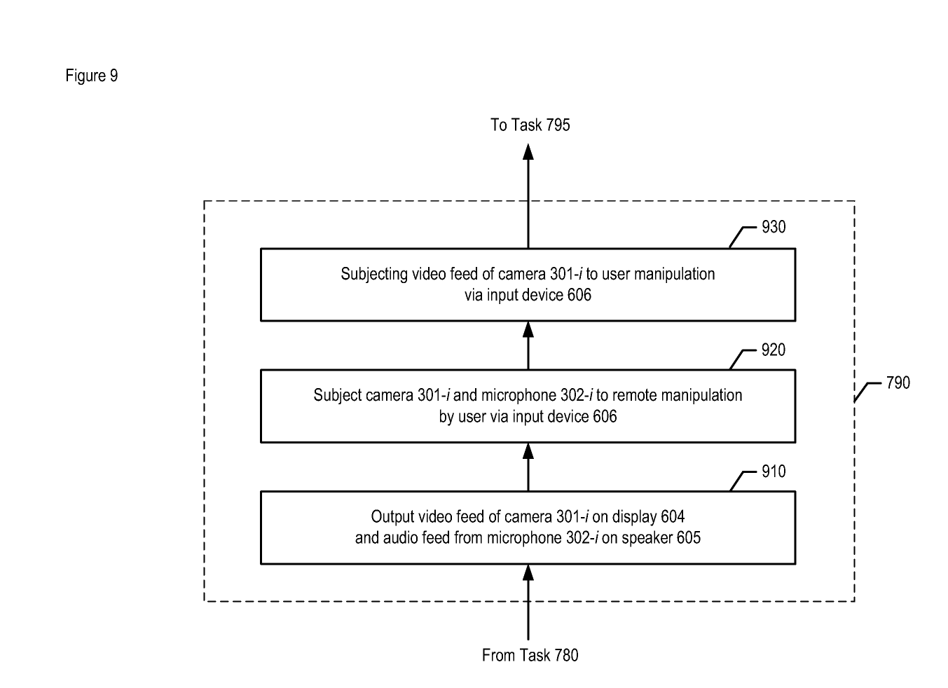

At task 790, relevant actions are performed, depending on the particular embodiment. The actions for the first, second, and third illustrative embodiments are described in detail below and with respect to FIG. 8, FIGS. 9 through 11, and FIG. 12, respectively.

At task 795, variable k is set to the value of i. After task 790, execution continues back at task 730.

FIG. 8 depicts a first detailed flowchart of task 790, in accordance with the first illustrative embodiment of the present invention.

At subtask 810, surveillance data-processing system 202 transmits a signal based on location L to surveillance apparatus 201-i that causes camera 301-i to photograph location L and microphone 302-i to capture sound from location L. As will be appreciated by those skilled in the art, in some other embodiments of the present invention, the signal transmitted by surveillance data-processing system 202 at subtask 810 might also be based on a predicted future location for wireless terminal T (e.g., a predicted future location based on the direction and speed of travel of wireless terminal T, etc.).

At subtask 820, the video feed of camera 301-i is output on display 604 and the audio feed from microphone 302-i is output on speaker 605, in well-known fashion. After subtask 820, execution continues at task 795 of FIG. 7.

As will be appreciated by those skilled in the art, in some other embodiments of the present invention, one or more other actions might be performed at subtask 820 in addition to, or instead of, outputting the audio/video feed. For example, in some other embodiments of the present invention, the feed might be archived for future retrieval. As another example, in some other embodiments of the present invention in which surveillance client 503 comprises N displays, the feed might be labeled, thereby enabling a user to conveniently select one of the displays. In any case, it will be clear to those skilled in the art, after reading this disclosure, how to make and use such alternative embodiments.

FIG. 9 depicts a second detailed flowchart of task 790, in accordance with the second illustrative embodiment of the present invention.

At subtask 910, the video feed of camera 301-i is output on display 604 and the audio feed from microphone 302-i is output on speaker 605, in well-known fashion. As noted above with respect to subtask 820, in some other embodiments of the present invention, one or more additional actions might be performed at subtask 910 (e.g., archiving the feed, etc.), and it will be clear to those skilled in the art, after reading this disclosure, how to make and use such alternative embodiments.

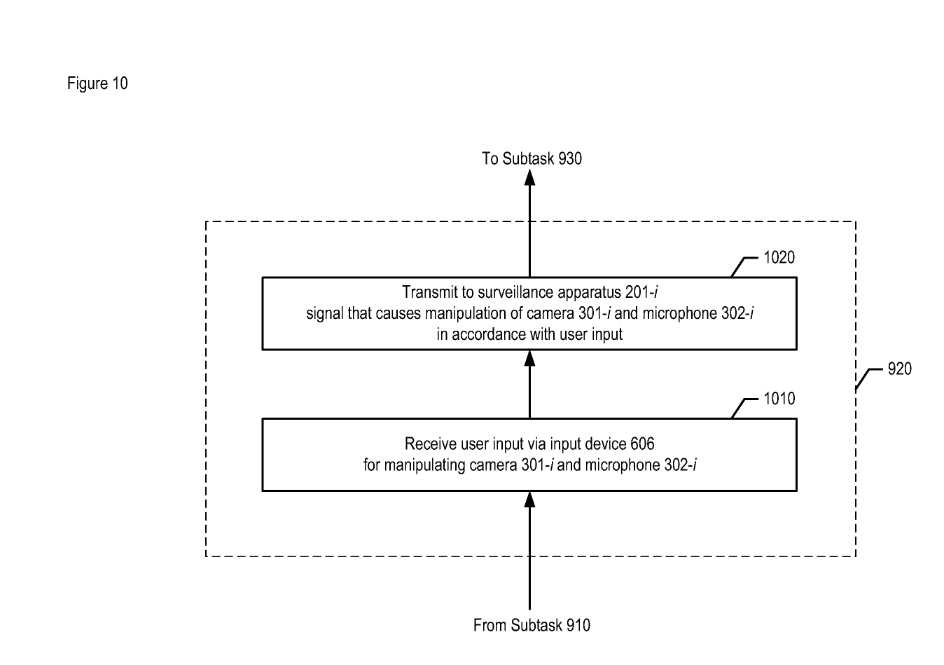

At subtask 920, camera 301-i and microphone 302-i are subjected to remote manipulation by a user of surveillance client 503, via input device 606. Subtask 920 is described in detail below and with respect to FIG. 10.

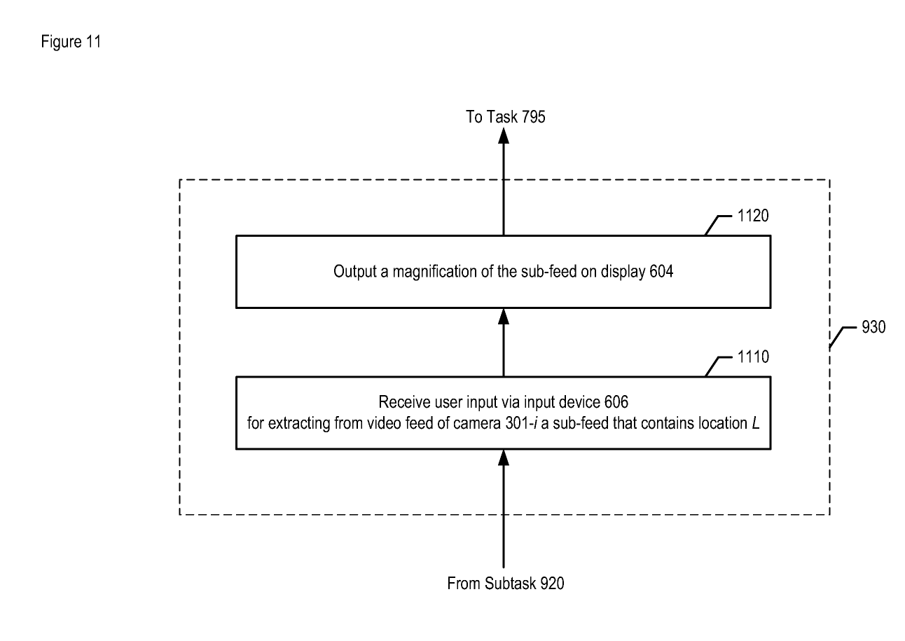

At subtask 930, the video feed from camera 301-i is subjected to manipulation by a user of surveillance client 503, via input device 606. Subtask 930 is described in detail below and with respect to FIG. 11.

After subtask 930, execution continues at task 795 of FIG. 7.

FIG. 10 depicts a detailed flowchart of subtask 920, in accordance with the second illustrative embodiment of the present invention.

At subtask 1010, user input for manipulating camera 301-i and microphone 302-i is received via input device 606. For example, if input device 606 is a mouse, side-to-side movements of the mouse might correspond to lateral panning of camera 301-i and microphone 302-i, up-and-down movements of the mouse might correspond to vertical panning of camera 301-i and microphone 302-i, and rotation of a wheel on the mouse might correspond to zooming of camera 301-i's lens. As another example, if display 605 and input device 606 are combined into a touchscreen, then touching a particular pixel area of the video feed might indicate that camera 301-i should photograph the location corresponding to the pixel area.

At subtask 1020, surveillance data-processing system 202 transmits to surveillance apparatus 201-i a signal that causes manipulation of camera 301-i and microphone 302-i in accordance with the user input. After subtask 1020, execution continues at subtask 930 of FIG. 9.

FIG. 11 depicts a detailed flowchart of subtask 930, in accordance with the second illustrative embodiment of the present invention.

At subtask 1110, user input is received via input device 606 for extracting from the video feed of camera 301-i a sub-feed that contains location L. For example, in some embodiments where input device 606 is a mouse, a user might use the mouse to define a rectangular sub-feed for extraction as follows:
positioning a cursor (that is superimposed on display 505 over the video feed) at a first point that corresponds to a first corner of a rectangle,
depressing and holding down a mouse button,
moving the cursor to a second point that corresponds to a second corner of the rectangle, and
releasing the mouse button.

Alternatively, in some other embodiments of the present invention, a user might position the cursor on the person of interest (i.e., the person associated with wireless terminal T) and click on the mouse button, thereby defining the center of a rectangular sub-feed for extraction. As will be appreciated by those skilled in the art, in some such embodiments there might be a pre-defined width and length of the rectangular sub-feed (e.g., 400 pixels by 300 pixels, etc.) while in some other embodiments the user might specify these dimensions (e.g., via text input, via one or more mouse gestures, etc.).

As will further be appreciated by those skilled in the art, in some such embodiments where the user clicks on the person or interest, the coordinates of the mouse click might be used to generate an azimuth measurement from camera 301-i, which could then be fed back to wireless location system 101 to improve the location estimate for wireless terminal T. Moreover, once the user has identified the person of interest (or “target”) in this manner, such embodiments might employ image-processing software that is capable of continuously tracking the target, thereby enabling surveillance system 102 to continuously generate azimuth measurements and provide the measurements to wireless location system 101. Still further, such continuous target tracking could be incorporated into the method of FIG. 7 in the detection and handling of “handoffs” between surveillance apparatuses when a target moves between zones.

At subtask 1120, a magnification of the sub-feed is output on display 604, in well-known fashion. After subtask 1120, execution continues at task 795 of FIG. 7.

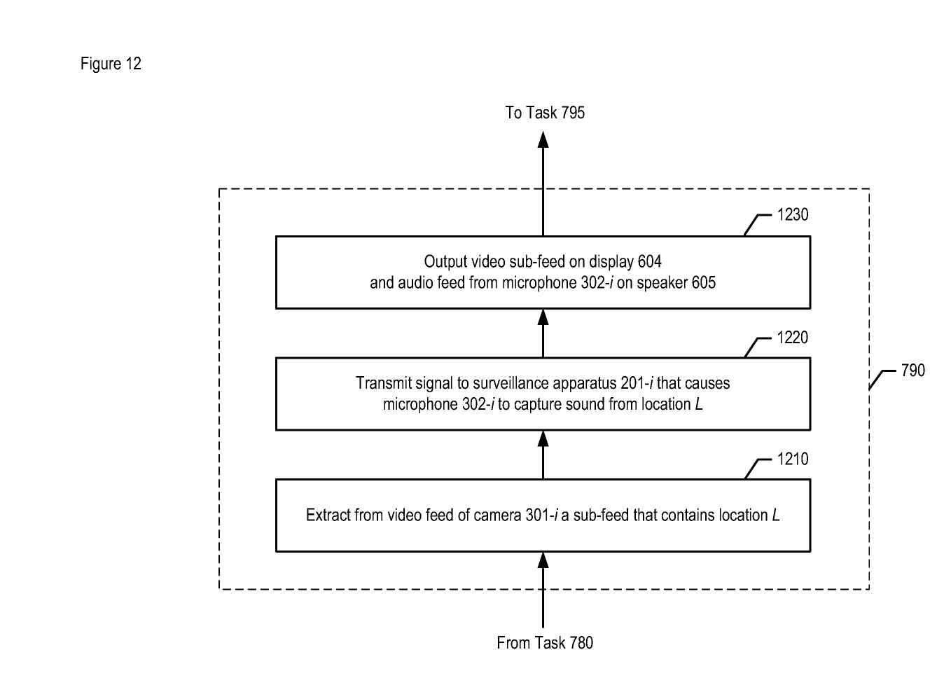

FIG. 12 depicts a third detailed flowchart of task 790, in accordance with the third illustrative embodiment of the present invention.

At subtask 1210, a sub-feed that contains location L is extracted from the video feed of camera 301-i. For example, in some embodiments, a rectangular sub-array of pixels that is centered on location L might be extracted from the full rectangular array of pixels of the video feed, in well-known fashion.

At subtask 1220, surveillance data-processing system 202 transmits to surveillance apparatus 201-i a signal that causes microphone 302-i to capture sound from location L (e.g., by aiming microphone 302-i in the direction of location L, etc.).

At subtask 1230, the video sub-feed is output on display 604 and the audio feed from microphone 302-i is output on speaker 605, in well-known fashion. After subtask 1230, execution continues at task 795 of FIG. 7.

As noted above with respect to subtasks 820 and 910, in some other embodiments of the present invention, one or more other actions might be performed at subtask 1230 in addition to, or instead of, outputting a magnification of the sub-feed (e.g., archiving the sub-feed, etc.), and it will be clear to those skilled in the art, after reading this disclosure, how to make and use such alternative embodiments.

As will further be appreciated by those skilled in the art, in some other embodiments of the present invention, there might be a location that can be photographed by two or more cameras. For example, in some such embodiments, such a location might be situated at the border of two adjacent zones (e.g., a street intersection, a corner inside a building, etc.), while in some other such embodiments, a zone might contain a plurality of cameras, rather than a single camera.

As will be appreciated by those skilled in the art, the manner in which feeds are handled in such embodiments is essentially a design and implementation choice. For example, in some such embodiments, all feeds that photograph the estimated location of wireless terminal T might be delivered to surveillance data-processing system 202, while in some other such embodiments, one of the feeds might be selected (e.g., based on which feed has the clearest picture of the person of interest, etc.). In any case, it will be clear to those skilled in the art, after reading this disclosure, how to modify the flowcharts of the illustrative embodiments to enable such functionality, and how to make and use embodiments of the present invention that implement the modified flowcharts.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, by a data-processing system:
(i) an identifier of a wireless terminal, and
(ii) an estimate of a location that comprises said wireless terminal; and
transmitting, from said data-processing system, a signal that causes a camera to photograph said location.

2. The method of claim 1 further comprising selecting said camera from a plurality of cameras based on said estimate of said location.

3. The method of claim 1 wherein said signal causes a change in the position of said camera.

4. The method of claim 1 wherein said signal causes a change in the orientation of said camera.

5. The method of claim 1 wherein said signal causes an adjustment of a lens of said camera.

6. The method of claim 1 wherein said signal is based on said estimate of said location.

7. The method of claim 6 wherein said signal is also based on a prior estimate of the location of said wireless terminal.

8. A method comprising:
receiving, by a data-processing system:
(i) an identifier of a wireless terminal,
(ii) an estimate of a location that comprises said wireless terminal, and
(iii) a video feed of an area that comprises said location; and
extracting from said video feed, by said data-processing system, a sub-feed that contains said location.

9. The method of claim 8 further comprising outputting said sub-feed on a display.

10. A method comprising:
receiving, by a data-processing system, an estimate of the location of a wireless terminal;
selecting, by said data-processing system, a camera from a plurality of cameras based on the estimated location of said wireless terminal; and
receiving, by said data-processing system, a video feed from the selected camera.

11. The method of claim 10 further comprising:
outputting said video feed on a display; and
subjecting the selected camera to remote manipulation by a user of an input device.

12. The method of claim 10 wherein said remote manipulation causes a change in the orientation of said camera.

13. The method of claim 10 wherein said remote manipulation causes an adjustment of a lens of said camera.

14. The method of claim 10 further comprising:
outputting said video feed on a display; and
subjecting said video feed to manipulation by a user of an input device.

15. The method of claim 14 wherein said manipulation comprises extracting from said video feed a sub-feed that contains said location, and wherein said method further comprises outputting a magnification of said sub-feed on said display.

16. The method of claim 10 wherein the estimate of the location of the wireless terminal is received from a wireless location system, said method further comprising:
outputting said video feed on a display;
receiving, via an input device, a user input that indicates an approximate location of said wireless terminal within the video feed;
generating, based on said user input, an azimuth measurement from the selected camera to said wireless terminal; and
transmitting said azimuth measurement to said wireless location system.

17. A method comprising:
(i) receiving, by a data-processing system, a first estimate of the location of a wireless terminal at a first time;
(ii) receiving, by said data-processing system, a second estimate of the location of the wireless terminal at a second time that is later than the first time; and
(iii) transmitting from said data-processing system:
(a) a first signal for de-selecting a video feed from a first camera that is photographing the location of the wireless terminal at the first time, and
(b) a second signal that causes a second camera to photograph the location of the wireless terminal at the second time.

18. The method of claim 17 wherein said second camera is selected from a plurality of cameras based on the second estimate of the location of the wireless terminal at the second time.

19. The method of claim 17 wherein said second signal causes a change in the orientation of said second camera.

20. A method comprising:
receiving, by a data-processing system:
(i) an identifier of a wireless terminal, and
(ii) an estimate of a location that comprises said wireless terminal; and
transmitting, from said data-processing system, a signal that causes a microphone to receive sound emanating from said location.

21. The method of claim 20 further comprising selecting said microphone from a plurality of microphone based on said estimate of said location.

22. The method of claim 20 wherein said signal causes a change in the orientation of said microphone.

23. A method comprising:
(i) receiving, by a data-processing system, a first estimate of the location of a wireless terminal at a first time;
(ii) receiving, by said data-processing system, a second estimate of the location of the wireless terminal at a second time that is later than the first time; and
(iii) transmitting from said data-processing system:
(a) a first signal for de-selecting an audio feed from a first microphone that is capturing sound from the location of the wireless terminal at the first time, and
(b) a second signal that causes a second microphone to capture sound from the location of the wireless terminal at the second time.

24. The method of claim 23 wherein said second microphone is selected from a plurality of microphones based on the second estimate of the location of the wireless terminal at the second time.

25. A method comprising:
receiving, by a data-processing system, a video feed from a camera, wherein said camera photographs an area in which a target is located, and wherein the location of said target is estimated by a wireless location system;
outputting said video feed on a display;
receiving, by said data-processing system, a user input that indicates an approximate location of said target within said video feed;
generating, based on said user input, an azimuth measurement from the selected camera to said target; and
transmitting said azimuth measurement from said data-processing system to said wireless location system.

26. The method of claim 25 further comprising:
receiving, by said wireless location system, said azimuth measurement; and
generating, by said wireless location system, a new estimate of the location of said target based, at least in part, on said azimuth measurement.
